(19) United States
(12) Patent Application Publication
(10) Pub. No.: US 2005/0285448 A1
(43) Pub. Date: Dec. 29, 2005

(54) Apparatus for controlling a load from both a wall switch and a local switch

(76) Inventor: David Cane, Cambridge, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/872,901

(22) Filed: Jun. 21, 2004

(51) Int. Cl. H02B 1/24

(52) U.S. Cl. 307/114

(57) ABSTRACT

A switching controller that allows a load to be controlled from either a switched wall outlet or a switch local to the load. A standard “3 way” SPDT wall switch replaces the normal SPST switch to allow for simple generation of a control pulse that is detected by the local control device to allow a change of state of the power provided to the load from either the wall switch or a manual switch directly connected to the control device.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

In household electrical systems, it is common to supply a wall outlet with electrical power through a wall switch positioned near an entryway. A lamp may then be plugged into the switched wall outlet. If the switch at the lamp is left on, the lamp can be turned on and off from the wall switch. This allows a person entering a dark room to turn on the lamp from the wall switch and avoids the need to search for the lamp switch in the dark.

Commonly, however, it is more convenient to turn the lamp off using the switch near the lamp. As a result, when the person leaves and later re-enters the room after dark, an attempt to turn on the lamp at the wall switch fails. Also, if the wall switch is turned off, the lamp cannot be turned on using the lamp switch. The bedside lamp illustrates the problem. While it is convenient to turn the lamp on using the wall switch when entering the room after dark, it is more convenient to use the switch near the lamp to turn the lamp off when retiring. As a result, in the morning when the room is well lit by daylight, the bedside lamp switch is typically left switched off. Thus at nightime when the room is reentered, the wall switch can't be used to turn the lamp on again.

It would thus be desirable to provide a switching device that can be used to control a lamp that is plugged into a switched outlet from either the wall switch or the lamp switch.

Various devices have been disclosed over the years to resolve this problem. Platzer (U.S. Pat. No. 3,872,319) requires two outlets, switched and un-switched, with local circuitry to provide the capability. Liang (U.S. Pat. No. 4,383,186) describes the use of relays to provide the various switching states but also suffers from the need to use two wall outlets to control a single lamp. Bennett (U.S. Pat. No. 5,574,319) overcomes the two outlet requirement by requiring the operator to flip the wall switch off and then on again for each desired change in lamp state. Bennett suffers from the additional problem that if the wall switch is left in the “off” state, the local switch cannot be used to turn the lamp on again. Logan (U.S. Pat. No. 6,710,553) provides a variation on Bennett that allows the original lamp switch to be used as the local switch, as well as providing an alarm if the wall switch is accidentally left in the “off” position.

The implementations of the above cited patents all have the disadvantages of either requiring two wall outlets or double actuation of the wall switch by a user. Moreover, if the user leaves the wall switch in the wrong state the lamp switch becomes inoperative. There is a continuing need to have a control device that allows for the simple actuation of a wall switch, does not require two electrical outlets, and has no failure modes.

### BRIEF SUMMARY OF THE INVENTION

This invention relates to electrical power control circuitry and more particularly to apparatus for controlling a lamp or other electrical load using either a remote wall SPDT switch or a local switch to control the power delivered to the load.

In accordance with the present invention, apparatus is provided for controlling a lamp or other electrical load that is connected to a wall socket under the control of a wall mounted switch. The state of the lamp (either on or off) is toggled when either the wall mounted switch is moved to its opposite position or the local switch associated with the controlling device is actuated. The local switch may be any one of a toggle switch, a pushbutton, or a touch switch. The apparatus includes control circuitry operative in response to a control signal from the wall switch or from the local switch.

The control signal from the wall switch is provided by the use of a break before make SPDT switch with both of its poles tied together. This creates a brief interruption to the flow of power to the wall socket, which is detected by the control circuit to change the lamp state. The control signal from the local switch is provided by a change in the switch state caused by manual actuation of the local switch.

In a further embodiment, the local switch may be used to control the brightness levels of the lamp, providing the equivalent of a three way bulb for the price of a simple bulb. As an alternative, the local switch may be used as a continuous dimmer control.

These and other objects, features and advantages of the invention will be more clearly understood by considering the following detailed description of a preferred embodiment of the invention. In the course of this description, frequent reference will be made to the attached drawings.

### BRIEF DESCRIPTION OF THE SEVERAL VIEWS OF THE DRAWINGS

FIG. 1 is a schematic block diagram of the invention;

FIG. 2 is a circuit diagram of a microprocessor based implementation showing a preferred embodiment;

FIGS. 3a and 3b show the flow chart of the operation of microprocessor implementing the control functions;

FIGS. 4 shows one physical package for the circuitry of FIG. 2;

FIG. 5 shows another package of the circuitry for inclusion in a lamp socket; and

FIG. 6 shows a package of the circuitry in a separate socket.

### DETAILED DESCRIPTION OF THE INVENTION

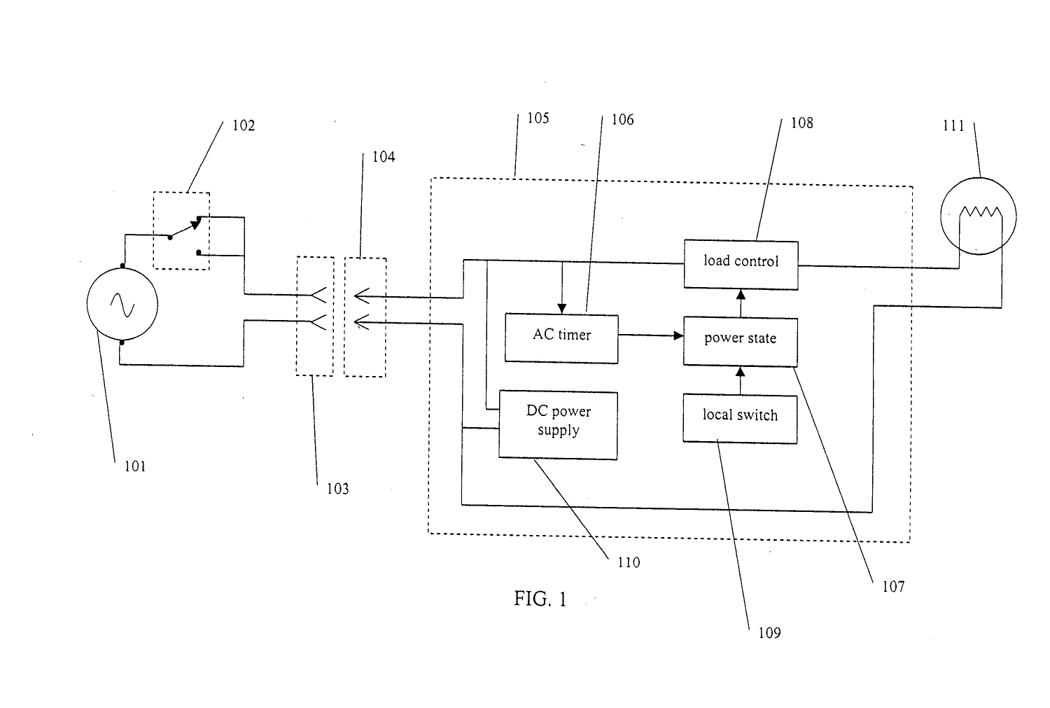

Referring to FIG. 1, wall switch 102 controls the flow of power from supply 101 to wall outlet 103. Power is maintained at wall outlet 103 for either position of wall switch 102, but when the switch is toggled, a brief interruption of the power occurs as the switch armature moves from one pole to the other. Wall switch 102 is a single pole double throw (SPDT) switch, readily available in electrical supply stores where they are commonly known as “3 way” switches. A pushbutton which is normally closed could be used as well.

Control device 105 is connected to wall outlet 103 via wall plug 104. Used in conjunction with wall switch 102, it provides the key mechanism for effecting the load control from either of the two locations. Power supply 110 provides low voltage DC power for the operation of the other circuits that make up control device 105.

AC timer 106 is used to detect the momentary power loss when wall switch 102 is actuated. It is reset with each zero crossing of the AC supply 101. For 60 Hz power, this occurs approximately every 8 milliseconds, or 10 milliseconds for 50 Hz power. As an alternative, it could be reset once each cycle, with periods twice as long as mentioned above. Timer 106 is set to expire with a period of approximately 10 milliseconds, so that an expiration of the timer indicates that wall switch 102 has been actuated.

An expiration signal from timer 106 is sent to power state register 107 which in turn controls load control 108 to deliver power to load 111. In the simplest embodiment, power state register has two states, ON and OFF, which cause load control 108 to deliver power, or not, respectively. Each time an expiration signal is received from timer 106, power state register 107 is toggled to its opposite state, thereby allowing wall switch 102 to control the power delivered to load 111. Load control 108 may be any one of a variety of electrically controlled power switches, for example, a relay or a solid state device such as a triac.

Local switch 109 provides the other mechanism for controlling power to the load. Each time it is actuated, power state register 107 toggles to its opposite state, controlling power to load 111 via load control 108. Local switch 109 may be any kind of switch, including pushbutton, toggle, rotary, touch, etc.

A mechanism must be provided such that power state register 107 retains its state during the power interruption caused by the actuation of wall switch 102. Typically this is done by having power supply 110 have sufficient capacitance to provide enough energy to the power state register 107 for the duration of the power interruption. As an alternative embodiment, power state register 107 can be built out of non volatile semiconductor memory, such as electrically erasable programmable read only memory (EEPROM) or flash memory.

In an alternative embodiment, power state register 107 may have more states than just two. For example, three brightness levels for a lamp may be achieved by assigning four states to power state register, representing off and three brightness levels. For this embodiment, load control 108 must be capable of delivering partial power, not just on or off. Details of how this control is effected will be described later in this detailed description.

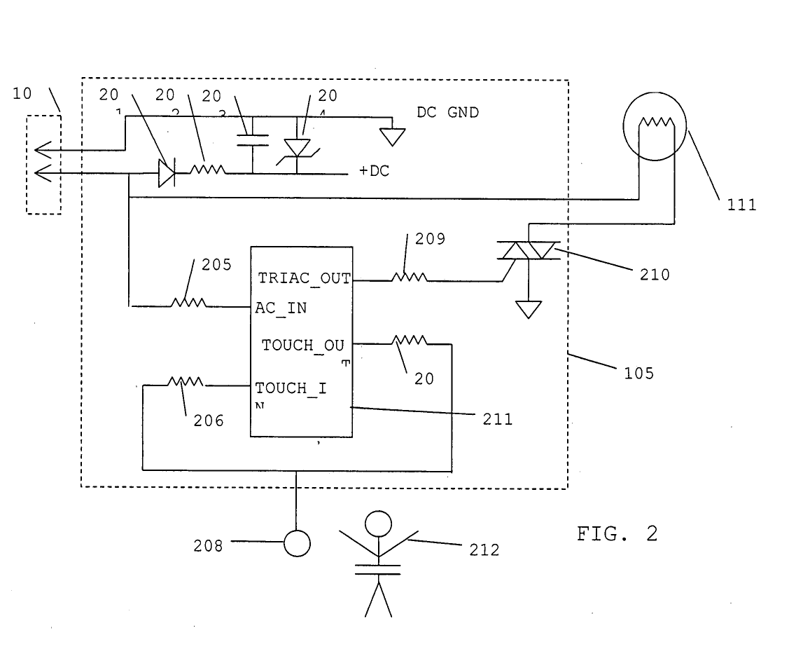

Referring to FIG. 2. as a preferred embodiment of control device 105 based on the use of a single chip microcontroller to implement ac timer 106, power state register 107, and a capacitive touch switch as local switch 109. A typical choice for microcontroller 211 would be part number 12C508 from the Microchip corporation, but there many inexpensive microcontroller devices from a variety of vendors that would serve equally well.

Power supply 110 is a conventional half wave rectified, capacitor filter supply of a design well known to those familiar with the art. Diode 201 rectifies the AC signal to DC, resistor 202 allows for a voltage drop from the high AC voltage to the low DC voltage (typically 3-5 volts), and capacitor 103 provides for energy storage and delivery during the half cycle of AC when diode 201 is not conducting as well as during the power interruption when switch 102 is actuated. Zener diode 204 provides voltage regulation.

Resistor 205 is a high value resistor that allows the microcontroller 211 to sense the zero crossings of the AC supply to reset the AC timer. As will be seen in a discussion of the software, this zero crossing signal will also be used to help implement the touch switch as well as to control the timing of an actuation signal to the triac 210 through resistor 209.

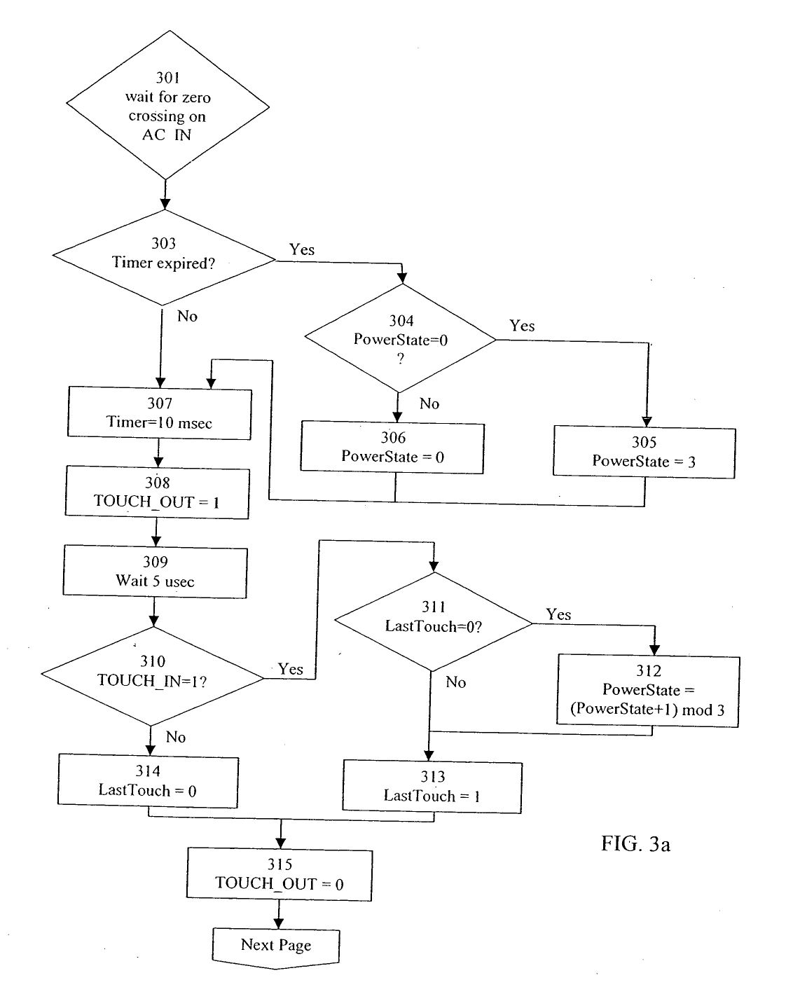

Resistors 207 and 206 as well as touch point 208 make up the touch switch. At each zero crossing of the AC supply a pulse will be put out on the TOUCH_OUT output of microcontroller 211 and sensed several microseconds later. If a person 212 is touching sense point 208, the RC delay of resistor 207 and the capacitance of person 212 (typically greater than 30 picofarads) will prevent the pulse from being sensed on input TOUCH_IN. If there is no person in contact with sense point 208, then the pulse will be sensed on input TOUCH_IN. This will be used to control the power to the load as described in the flowchart in FIGS. 3a and 3b.

Triac 210 implements load control 108 in conjunction with microcontroller 211. Resistor 209 limits the flow of current through microcontroller 211.

The flowchart of FIGS. 3a and 3b shows the software implementation for a control device that implements both the local and remote control mechanisms, as well as providing a three level power control for lamp dimming.

The PowerState variable represents the value of power to be delivered to the load. It takes on values 0, 1, 2, and 3 which represent off, one third, two thirds power, and full power, respectively.

The LastTouch variable is used to keep track of a person touching the terminal for the local switch which in the illustrated embodiment is a touch switch. The touch switch is sampled on each zero crossing of the AC line and an actuation is defined to occur when a person is touching the sense point and was not on the previous sample. LastTouch has the value 1 if the previous sample indicated a touch.

Step 301 waits for a zero crossing of the AC line. The subsequent steps depend on this synchronization event.

Steps 303 through 306 are used to detect an AC power interruption and change the power state appropriately upon such detection. Step 303 checks to see if the timer has expired. Since zero crossings occur approximately every 8 milliseconds and the timer is set to expire after 10 milliseconds, an expiration of the timer means that AC power had been lost and the program waited at step 301 for longer than a normal half cycle of the AC line. If the timer expires, the program goes to step 304 which checks to see if any power had been delivered to the load. If PowerState has any value but 0 , some power is present and the program turns the power in step 305 by setting PowerState to 0 . If PowerState has a 0 value, then power was off, and the program turns the power on in Step 306 by setting it to 3, for full power. As an alternative, the power can be configured to bring the power up at a value less than full power, if that was deemed preferable for some applications.

For the final handling of the power interruption algorithm, the timer is reset to its starting value in step 307.

Steps 308 through 314 deal with the handling of the touch switch. Steps 308 through 310 assert the TOUCH_OUT pin high, wait 5 microseconds, and then read the TOUCH_IN pin. If no one was touching the sense terminal, the TOUCH_IN pin will be high because it is driven by the TOUCH_OUT pin. If , however, a person is touching the terminal, the TOUCH_IN pin will read low because the short delay is not enough to allow the pin to become high, given the delay caused by resistor 207 and body capacitance of the person touching the sense terminal.

If a touch is sensed, the program goes to step 311 and checks whether the touch was present the last time through the loop. If so, then this is not the moment of initial touch, and no change is made to PowerState. If, however, it is the initial touch, then the PowerState variable is advanced to its next valid value in step 312. This causes successive touches on the sense terminal to advance the control device through all of the brightness levels, including off.

Steps 313 and 314 set the LastTouch variable to the current state of the sense terminal, so that it has a valid value for the next pass through the loop. Step 315 resets the TOUCH_OUT pin to be ready for the next cycle.

Step 316 disables control power to the triac at the zero crossing. This is in preparation for the following steps.

Steps 317 through 320 control the power delivered to the load by triac 210 in accordance with the value of the PowerState variable. The power control employs a phase control mechanism, which itself is well known to those familiar with the art. A more detailed description of how triac phase control works may be found, as an example, in Teccor Electronics document AN1003, “Phase Control Using Thyristors”, 2002. A simple summary for the purposes of this description is that the power delivered to the load is a function of the delay from AC zero crossing at which the triac is turned on. The longer the delay, the less power is delivered to the load.

Step 317 checks the value of PowerState. If 0, no power should be delivered, and the program goes back to step 301 to wait for the next zero crossing of the AC line.

If PowerState is 1, then we wish to deliver one third power to the load and this is accomplished by waiting approximately 60% of the half cycle before turning on the triac. For a 60 Hz line, this is about 5 milliseconds. Step 318 implements this.

If PowerState is 2, step 319 sets a delay of 3.5 milliseconds.

If PowerState is 3, full power requires that the triac be turned on without appreciable delay.

Steps 320 activates the triac to deliver power to the load.

Although the preferred embodiment described above shows a four state power level system, it should be apparent to those skilled in the art that modified embodiments can provide either more or fewer power levels.

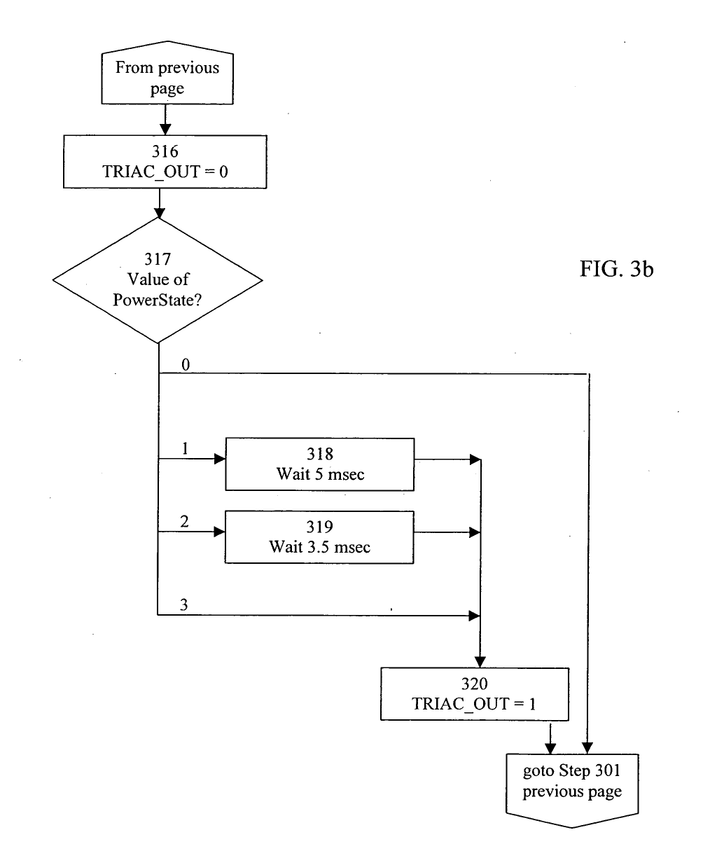

FIG. 4 shows one packaging configuration for control device 105. The circuitry is placed on a printed circuit board 403 inside a plastic case 401 through which the lamp power cord 402 passes. The AC hot side of the cord 402 is cut to allow the control device to switch the power to the lamp side of the cord. Connection is made between the printed circuit board 403 by three pins 404 which pierce the insulation on cord 402 and touch the inner conductors. As an alternative embodiment, screw or friction terminals could be used. A connection from the circuit board 403 is made to metal plate 208 for the touch switch. Cover 405 protects the user from harmful voltages.

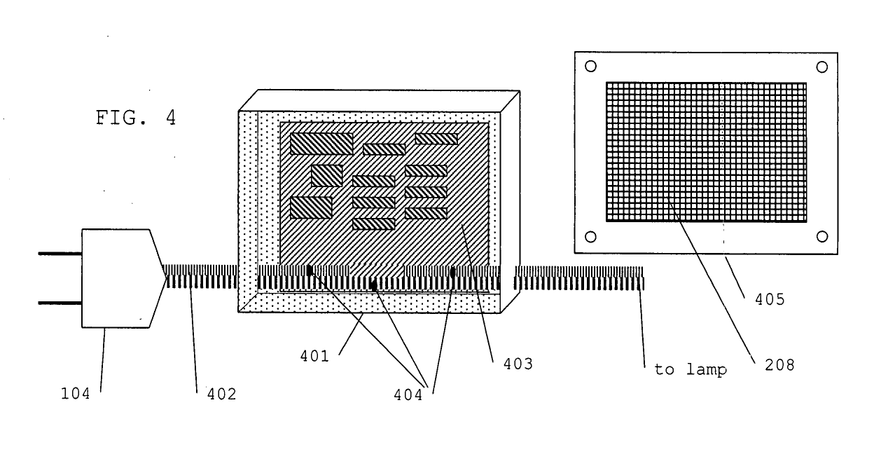

FIG. 5 shows an alternative package in which the control device is packaged on a printed circuit board 501 housed inside a standard metallic lamp socket 502. The metal shell of the lamp socket serves as the sense terminal. The socket may be placed in any lamp base, with base 503 shown as an example

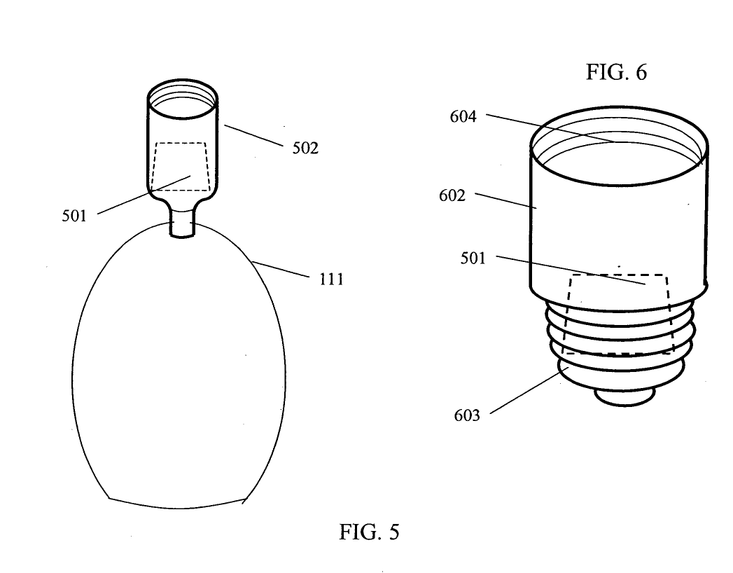

FIG. 6. shows yet another alternative package in which the control device printed circuit 501 is placed inside a lamp socket 602 which screws into the existing socket of a lamp via male threads 603 and provides a socket for the bulb via female threads 604. The metal shell of the lamp socket serves as the sense terminal.

It will be recognized that any of the package configurations shown in FIGS. 4-6 could accommodate a mechanical switch instead of a touch switch. It is also to be understood that the specific embodiment of the invention, which has been described, is merely illustrative and that modifications may be made to the arrangement described without departing from the true spirit and scope of the invention

1. Apparatus for controlling an electrical load comprising:
a first operator actuated momentary interrupting switch for providing and momentarily interrupting power to an electrical outlet;
a control device having a second operator actuated switch and operative to change state upon activation of either said first switch or said second switch; and
an electrical load device, such that a state change in either of said switches will cause a change in power delivered to an electrical load device connected to the electrical outlet and to the controller.

2. The apparatus of claim 1 in which said first switch comprises a single pole double throw switch with both poles electrically connected together.

3. The apparatus of claim 1 in which said second switch is actuated by the presence of a person touching a sense terminal thereof.

4. The apparatus of claim 1 in which said control device causes a change in power of at least two states of power including no power and full power.

5. The apparatus of claim 1 in which said control device causes a change in power of greater than two states including no power, full power, and one or more states of differing levels of delivered power between no power and full power.

6. The apparatus of claim 1 in which said control device includes a timing circuit for detecting the interruption of power caused by said first switch, a memory circuit for maintaining the desired power state, a power control circuit for establishing the power to said load device, and a circuit for supplying operating power to one or more of said timing, memory, and power control circuits.

7. The apparatus of claim 6 in which said memory circuit comprises a non volatile semiconductor memory to maintain the desired power state when said first switch interrupts power to said control device.

8. Apparatus for controlling an electrical load comprising:
a first switch connected to an electrical outlet and operative upon actuation to momentarily interrupt power to the electrical outlet; and
a controller connected to the electrical outlet and having a second switch operative upon actuation to change state, the controller operative to change the power to a load connectable to the controller; whereby actuation of such first switch or said second switch causes a change in power to the load.

9. The apparatus of claim 8 wherein the electrical load is a lamp.

10. The apparatus of claim 8 wherein the controller is packaged in a housing attachable to an electrical cord which powers the electrical load.

11. The apparatus of claim 9 wherein the controller is packaged in a lamp socket.
